(19) United States
(12) Patent Application Publication
(10) Pub. No.: US 2018/0315407 A1
(43) Pub. Date: Nov. 1, 2018

(54) Automatic Music Mixing

(71) Applicant: Microsoft Technology Licensing, LLC, Redmond, WA (US)

(72) Inventors: Harrison Wesley HOFFMAN, Seattle, WA (US); David Rowland SINCLAIR, Bellevue, WA (US); Laurentiu Titi NEDELCU, Redmond, WA (US); Adam Thomas MOLLIS, Seattle, WA (US); Sung-Hon WU, Issaquah, WA (US); Ahmed Raouf MEROUCHE, Seattle, WA (US); Brendan Mitchel WALSH, Seattle, WA (US)

(73) Assignee: Microsoft Technology Licensing, LLC, Redmond, WA (US)

(21) Appl. No.: 15/582,487

(22) Filed: Apr. 28, 2017

(51) Int. Cl. G10H 1/00; G06F 17/30; G06F 3/0484

(52) U.S. Cl. CPC G10H 1/0008; G06F 17/30772; G06F 17/30766; G10H 2240/081; G10H 2210/125; G10H 2240/075; G06F 3/04847

(57) ABSTRACT

Described herein is a system for automatically mixing music. An ordering component receives information regarding a set of songs, obtains pre-analyzed metadata about songs in the set of songs, and, based upon the pre-analyzed metadata orders the songs into a mix based upon an analysis of beats-per-minute and song key. A cue point component, based upon a user preference, selects one or more cue points from the pre-analyzed metadata for transitions into and/or out of the songs in the mix. A transition component, based upon the user preference and information derived from the pre-analyzed metadata for each section of a particular song, configures transitions between songs in the mix. The system can store metadata about the mix for playback.

### BACKGROUND

Creating a great sounding music mix can be complex and time consuming even for music professionals. For novices, the process of creating a music mix can be overwhelming.

### SUMMARY

Described herein is a system for automatically mixing music, comprising a computer comprising a processor and a memory. The memory comprises an ordering component configured to receive information regarding a set of songs, obtain pre-analyzed metadata about songs in the set of songs, and, based upon the pre-analyzed metadata order the songs into a mix based upon an analysis of beats-per-minute and song key. The memory further includes a cue point component configured to, based upon a user preference, selects one or more cue points from the pre-analyzed metadata for transitions into and/or out of the songs in the mix. The memory further includes a transition component configured to, based upon the user preference and information derived from the pre-analyzed metadata for each section of a particular song, configure transitions between songs in the mix. The system can store metadata about the mix for playback.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for automatically mixing music.

FIG. 2 is a functional block diagram that illustrates a system for automatically mixing music.

FIG. 3 illustrates an exemplary method of automatically mixing music.

FIG. 4 illustrates an exemplary method of automatically mixing music.

FIG. 5 is a functional block diagram that illustrates an exemplary computing system.

### DETAILED DESCRIPTION

Various technologies pertaining to automatic music mixing are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding automatic music mixing. What follows are one or more exemplary systems and methods.

Aspects of the subject disclosure pertain to the technical problem of music mixing. The technical features associated with addressing this problem involve ordering songs of a particular playlist. Ordering can be based groups with similar beats-per-minute, and, within each group, based upon songs that are harmonically similar (e.g., based upon key preference(s)). Cue point(s) and transition(s) can be generated for the ordered songs. Metadata associated with the ordered songs, cue point(s) and transition(s) can be stored as a mix. Optionally, a user can customize the mix. Accordingly, aspects of these technical features exhibit technical effects of more efficiently and effectively automatically generating a music mix, for example, increasing user satisfaction.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

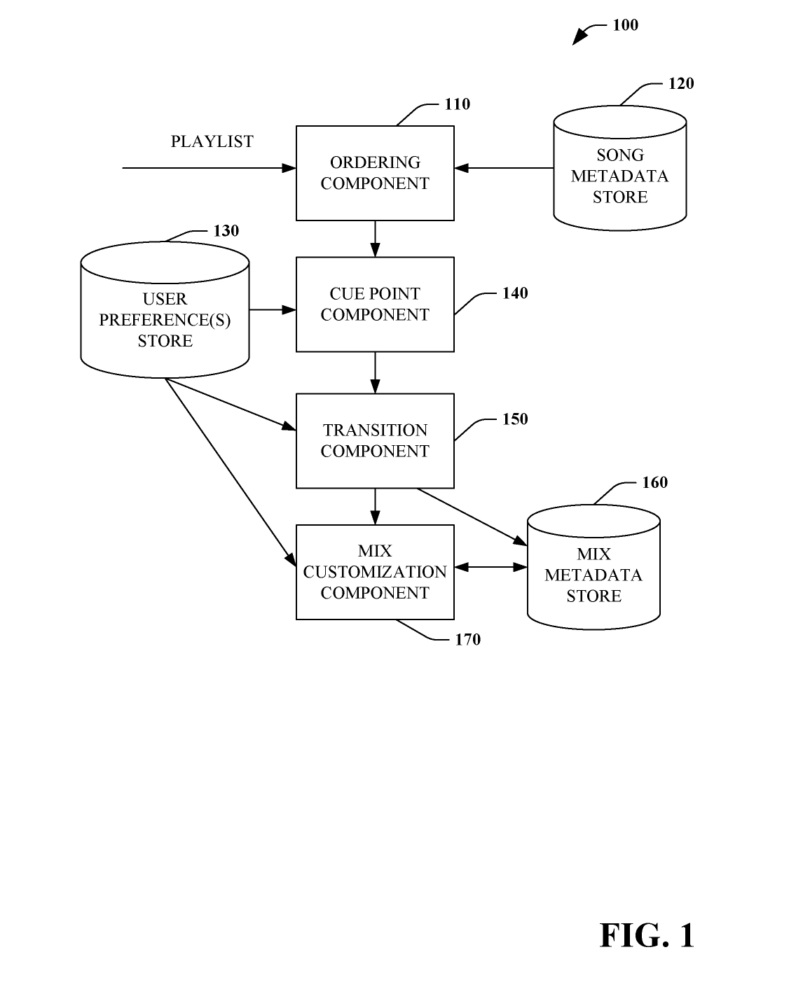

Referring to FIG. 1, a system for automatically mixing music 100 is illustrated. In one embodiment, the system 100 is invoked by a “mix” button on a graphical user interface associated with a particular playlist. The particular playlist is then provided to the system 100.

The system 100 automates mixing a set of songs (e.g., a playlist) by utilizing pre-analyzed information about each song (e.g., metadata) to order songs of a particular playlist. Ordering can be based groups with similar beats-per-minute, and, within each group, based upon songs that are harmonically similar (e.g., based upon key preference(s)). Cue point(s) and transition(s) can be generated for the ordered songs and metadata associated with the ordered songs, cue point(s) and transition(s) can be stored as a mix. A user can, optionally, customize the mix.

Conventionally, in order to create a music mix, a user would have to review a music collection and manually order, cue and transition songs by listening to each song. The system 100 provides automatic mixing of a set of songs, based on pre-analyzed music information, as well as options for customization by the user, and playback, roaming, and sharing functionality. The system 100 facilitates music mix creation by user(s) unfamiliar with music mix generation.

In one example, a user can submit a favorite playlist to the system 100 (e.g., by invoking a “mix” command). Automatically, all of the songs in the playlist get arranged so that the songs sound great together and the energy levels of the songs peak and drop at the right moments. High quality transitions are added at key points in all of the songs. The resulting mix sounds great, but there are a few transitions that the user would like to customize to make sound even better. The system 100 allows flexibility for the user to select from one or more suggested transition points in any of the songs whose transitions don't feel quite right and pick the type of transition that's used between each song. In the end, the user ends up with a mix that sounds great and that the user, optionally, has put the user's personal touch on. Thereafter, the mix can be shared, for example, with selected friend(s) and/or made pubic so that others can enjoy the user's new creation.

The system 100 includes an ordering component 110 that receives information regarding a set of songs (e.g., a playlist). The ordering component 110 obtains pre-analyzed metadata about songs in the set (e.g., each song), for example, from a song metadata store 120. For example, the song metadata store 120 can store the pre-analyzed metadata in a database or other suitable data structure to facilitate selective retrieval (e.g., indexed by song, genre, author, etc.). The pre-analyzed metadata can include, for example, genre, beats-per-minute, song key, information regarding one or more section(s) of a particular song, for example, average energy, duration time, cue point(s), transition information associated with each cue point, etc.

Based upon the pre-analyzed metadata, the ordering component 110 orders the songs, for example, so the songs are optimized for mixing. In one embodiment, the ordering component 110 orders the songs based upon the pre-analyzed metadata based upon an analysis of beats-per-minute and song key. In one embodiment, initially the ordering component 110 groups the songs based upon similar beats-per-minute, for example, in order to maximize the ability of the system 100 to create beat-matched transitions.

Next, within each group, the ordering component 110 orders the songs by a set of key preference(s) so that songs sound good mixed together harmonically. In one embodiment, the key preference(s) can preconfigured. In one embodiment, the key preference(s) are user-configurable. In one embodiment, the system 100 dynamically adapts the key preference(s) based upon observation(s) of user behavior when customizing previous mix(es).

The cue point component 140 obtains user preference(s) from a user preference(s) store 130, for example, a mix intensity preference (e.g., that effectively determines how much of each song the user will hear in the mix). In one embodiment, the mix intensity preference is received from the user via a graphical user interface. In one embodiment, the mix intensity preference quantifies a desired mix intensity of the user in one of a plurality of mix intensity levels (e.g., casual, standard, hyper, etc.). For example, “casual” can denote simple, short crossfades at the very end and beginning of songs, “standard” can denote a preference to hear the majority of each song, but transitions will occur at optimal cue points and may be more complex in nature (e.g., songs play with each other for longer, beat matching is applied, effects, more transition types, etc.). “Hyper” can denote an indication to make the mix feel like something the user would hear at a club. This mix moves quickly between songs and has more experimental and/or aggressive transitions.

Based upon the user preference(s), the cue point component 140 selects one or more cue points from the pre-analyzed metadata for transitions into and/or out of songs in the mix (e.g., based on the received set of song). In one embodiment, the cue point component 140 hierarchically ranks a plurality of cue points, with the highest ranking cue point(s) being selected as the cue point(s) for the song within the mix, and, other(s) being available to the user as alternative cue point(s) for the song during mix customization, as discussed below.

The transition component 150 utilizes user preference(s) from the user preference(s) store 130. In one embodiment, the transition component 150 utilizes the mix intensity preference previously obtained by the cue component 140. Based upon information derived from the pre-analyzed metadata for each section of a particular song, the transition component 150 configures transition(s) between songs in the mix. In one embodiment, the transition component 150 derives musical information about a section that each cue point represents and a transition duration and/or a set of effect(s) (e.g., volume, beat matching, etc.) is applied to the transition based on the derived musical information. In one embodiment, alternative transition option(s) are generated for at least some of the songs in the mix and are available to the user as alternative transition(s) for the song during mix customization, as discussed below.

Once the system 100 has ordered, selected cue points and generated transitions for the set of songs, the system 100 can store information regarding the ordering, cue points and transitions comprising the mix in a mix metadata store 160. In one embodiment, the information stored comprises metadata about the mix, for example, a set of instructions necessary for playback of the mix. In this embodiment, the actual set of songs are not stored with the metadata about the mix, but instead are available to a player at playback along with the metadata about the mix. In one embodiment, the information stored comprises metadata about the mix and the set of songs.

In one embodiment, mix(es) generated by the system 100 are portable and can be played by playback application(s) across platforms. In one embodiment, in order to accomplish portability, the mix metadata comprises a set of JavaScript Object Notation (“JSON”) instructions for any suitable playback application to playback the mix. A sample of instructions for one song is set forth in Table 1:

TABLE 1

{

tracks: [{

StartNextTrackAt: “0:0:0”,
EffectProperties: {

FileStartOffet: “0:0:0”,
FilePlayDuration: “0:0:0”,
TimeStretchFactor: 1.0,
PitchScaleFactor: 1.0,
Animations: [{

Type: “Volume”,
StartValue: 0.0,
EndValue: 1.0,
Offset: “0:0:0”,
Duration: “0:0:0”,
Hold: false,
GroupId: 1,
EasingFunction: {

Type: “CubicBezier”,
ControlPoints: [1.0, 1.0, 1.0, 1.0]

}

}]

}

}]

}

By storing metadata about the mix separate from the songs, mix(es) can be roamed to various device(s) without a need to upload and/or download fully composited mix music file(s). In one embodiment, user(s) can share their mix(es) with other user(s). In one embodiment, information about the mix stored in the mix metadata store 160 can be utilized to determine what portion(s) of song(s) have been listened to so that rights hold(s) associated with songs in the mix can be properly compensated.

Optionally, the user can customize (e.g., edit) the mix generated by the system 100 using a mix customization component 170. In one embodiment, the user can customize mix(es) by selecting a mix intensity that applies to the entire mix, for example, used by the cue point component 140 and/or the transition component 150, as discussed above. The mix intensity effectively dictates how much of each song the user will hear in the mix, for example, from simple crossfades at the very beginning and ends of songs to moving quickly through songs (e.g., “club mix”).

The user can utilize the mix customization component 170 to modify the mix. For example, once the mix has been generated by the system 100, if the user hears a transition that the user doesn't like, the user can have one or more option(s) to customize the mix. In one embodiment, the user can select an alternative transition previously stored by the transition component 150. For example, the user can preview how one or more of the alternative transitions sound and easily swap in the user's favorite.

In one embodiment, the user can select an alternative cue point (e.g., alternative cue points previously stored by the cue point component 140) in the song for the transition to occur. In one embodiment, in response to the user selecting an alternative cue point, the system 100 calculates another preferred transition and a set of alternative transitions for the user.

In one embodiment, the user can alter a transition, for example, by a beat or two. For example, the user can modify (e.g., nudge) the start of end of transition slightly forward or backwards, one beat at a time. This allow the user to customize the transition in a simple way while keeping the beat of the two songs aligned.

In one embodiment, the mix customization component 170 can facilitate granular control via one or more graphical user interfaces. For example, the user interfaces can allow the user to selectively adjust the duration(s), effect(s) and/or volume curve(s) of one or more transitions.

In one embodiment, the user can use editing functionality allowing access to a particular transition to see how the transition is construct in greater detail and make changes to the transition. In one embodiment, the user can re-order songs within the mix, for example, by a sample drag and drop input. In response, the system 100 will create new cue points and/or transitions for affected tracks.

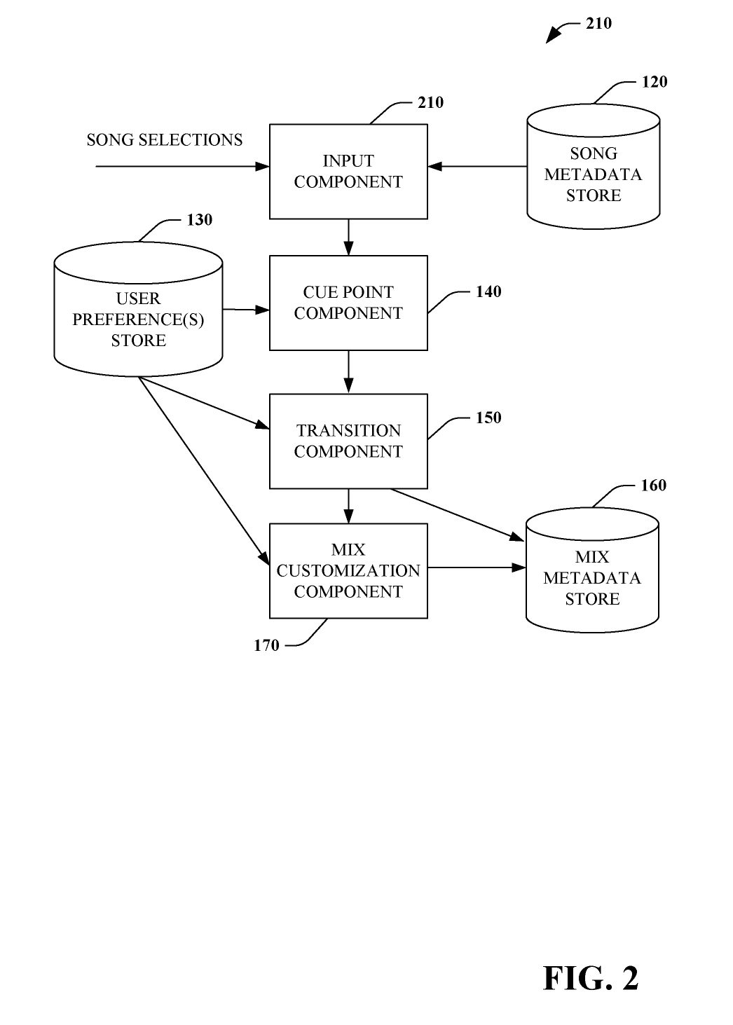

Turning to FIG. 2, a system for automatically mixing music 200 is illustrated. The system 200 automates mixing a set of songs by iteratively utilizing pre-analyzed information about each song (e.g., metadata) as each song is added to the mix during a mix composition session. In one embodiment, the system 200 preserves an order in which the songs were submitted to the mix by the user. In one embodiment, an order of the songs is customizable by the user.

The system 200 includes an input component 210 that receives user input for adding and/or removing a song from a mix. In response to a song being added to the mix, the input component 210 provides this information to a cue point component 140.

As discussed in greater detail above, the cue point component 140 obtains user preference(s) from a user preference(s) store 130, for example, a mix intensity preference. Based upon the user preference(s), the cue point component 140 selects one or more cue points from pre-analyzed metadata (obtained from the song metadata store 120) for transitions into and/or out of the song in the mix. For example, the cue points can be ranked hierarchically with cue points being selected for the song and other(s) being available to the user as alternative cue point(s) for the song during mix customization.

The system 200 further includes a transition component 150 that utilizes user preference(s) (e.g., the mix intensity preference). Based upon information derived from the pre-analyzed metadata for each section of the song, the transition component 150 configures transition(s) between the song and other songs in the mix. For example, the transition component 150 can derive musical information about a section that each cue point represents and a transition duration and/or a set of effect(s) (e.g., volume, beat matching, etc.) is applied to the transition. In one embodiment, alternative transition option(s) are generated for at least some of the transition(s) in the mix and are available to the user as alternative transition(s) for the song during mix customization.

The system 200 can receive additional song selection(s) from the user and iteratively add cue points and transitions to the song as it is added to the mix. Once an order set of songs defining the mix has been achieved, the user can utilize a mix customization component 170 to customize the mix. Once the mix has been created, and optionally customized, information regarding the mix (e.g., ordering, cue points and transitions comprising the mix) is stored a mix metadata store 160.

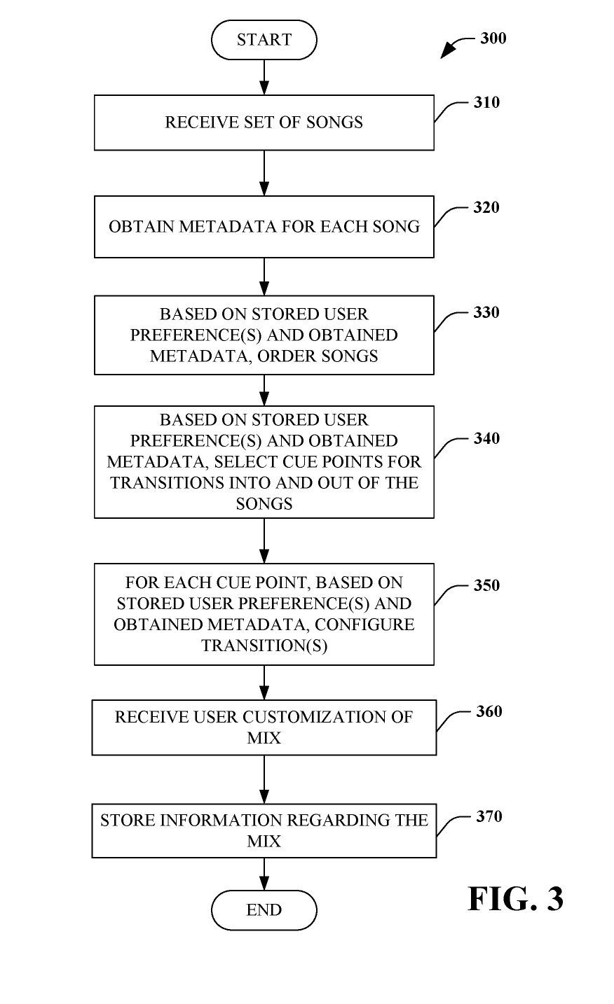

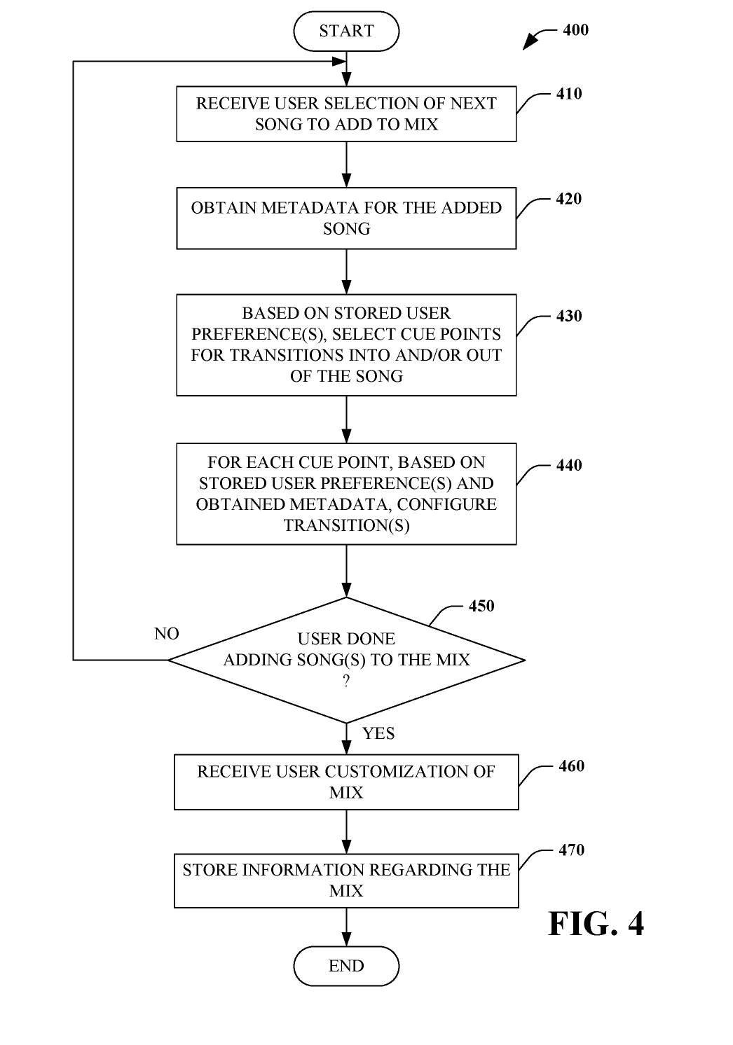

FIGS. 3 and 4 illustrate exemplary methodologies relating to automatically mixing music. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 3, a method of automatically mix music 300 is illustrated. The method 300 can, for example, facilitate transformation of an existing playlist into a mix.

At 310, a set of songs, for example, a playlist is received. At 320, metadata for each song is obtained, for example, from a song metadata store 120. The metadata comprises pre-analyzed information about each song, for example, genre, beats-per-minute, song key, information regarding one or more section(s) of a particular song, for example, average energy, duration time, cue point(s), transition information associated with each cue point, etc.

At 330, the songs are ordered based on stored user preference(s) (e.g., mix intensity) and the obtained metadata for each song. In one embodiment, the pre-analyzed information is used to order the songs (e.g., optimized for mixing). In one embodiment, initially the songs are placed into groups based upon similar beats-per-minute, for example, in order to maximize the ability to create beat-matched transitions. Next, within each group, the songs are ordered by a set of key preference(s) so that songs sound good mixed together harmonically. For example, the key preference(s) can preconfigured, user-configurable and/or dynamically adapted based upon observation(s) of user behavior when customizing previous mix(es).

At 340, cue points for transitions into and out of each the songs are selected based on stored user preference(s) (e.g., mix intensity) and the obtained metadata for each song. In one embodiment, cue points are hierarchically ranked cue points, with the highest ranking cue point(s) being selected as the cue point(s) for the song within the mix, and, other(s) being available to the user as alternative cue point(s) for the song during mix customization.

At 350, transitions between songs in the mix are configured for each selected cue point based on stored user preference(s) (e.g., mix intensity) and the obtained metadata for each song. In one embodiment, musical information about a section that each cue point represents is derived and a transition duration and/or a set of effect(s) (e.g., volume, beat matching, etc.) is applied to the transition. In one embodiment, alternative transition option(s) are generated for at least some of the transition(s) in the mix and are available to the user as alternative transition(s) for the song during mix customization.

At 360, user customization of the mix is received. For example, once the mix has been generated, if the user hears a transition that the user doesn't like, the user can have one or more option(s) to customize the mix. In one embodiment, the user can select an alternative previously stored transition.

In one embodiment, the user can select an alternative previously stored cue point in the song for the transition to occur. In response to the user selecting an alternative cue point, another preferred transition and a set of alternative transitions for the user can be calculated. In one embodiment, mix customization can include the user to selectively adjusting the duration(s), effect(s) and/or volume curve(s) of one or more transitions.

At 370, information regarding the mix is stored, for example, in a mix metadata store 160. In one embodiment, the information stored comprises metadata about the mix, for example, a set of instructions necessary for playback of the mix.

Turning to FIG. 4, a method of automatically mix music 400 is illustrated. The method 400 can, for example, facilitate a user creating a mix from scratch.

At 410, a user selection of a next song to be added to the mix is received. At 420, metadata for the added song is obtained, for example, from a song metadata store 120.

At 430, cue points for transitions into and out of the added song are selected based on stored user preference(s) (e.g., mix intensity) and the obtained metadata for the song. For example, cue points can be hierarchically ranked cue points, with the highest ranking cue point(s) being selected as the cue point(s) for the song within the mix, and, other(s) being available to the user as alternative cue point(s) for the song during mix customization.

At 440, transitions between songs in the mix are configured for the selected cue point based on stored user preference(s) (e.g., mix intensity) and the obtained metadata for each song. Optionally, alternative transitions are generated for at least some of the transition(s) in the mix and are available to the user as alternative transition(s) for the song during mix customization.

At 450, a determination is made as to whether the use is done adding songs to the mix. If the determination at 450 is NO, processing continues at 410. If the determination at 450 is YES , at 460, user customization of the mix is received. At 470, information regarding the mix is stored.

Described herein is a system for automatically mixing music comprising a computer comprising a processor and a memory. The memory can include an ordering component configured to receive information regarding a set of songs, obtain pre-analyzed metadata about songs in the set of songs, and, based upon the pre-analyzed metadata order the songs into a mix based upon an analysis of beats-per-minute and song key. The memory can further include a cue point component configured to, based upon a user preference, selects one or more cue points from the pre-analyzed metadata for transitions into and/or out of the songs in the mix. The memory can further include a transition component configured to, based upon the user preference and information derived from the pre-analyzed metadata for each section of a particular song, configure transitions between songs in the mix, wherein the system further stores metadata about the mix for playback.

The memory can include a mix customization component configured to receive user input to modify the mix comprising at least one of modification of a particular cue point or modification of a particular transition. The memory can further include a mix customization component configured to receive user input via a graphical user interface allowing a user to selectively adjust at least one of a duration, an effect or a volume curve of a particular transition.

The system can include wherein the pre-analyzed metadata comprises at least one of a genre, beats-per-minute or a song key. The system can further include wherein the pre-analyzed metadata comprises information regarding one or more section(s) of a particular song including at least one of an average energy, a duration time, a cue point or transition information associated with a cue point. The system can include wherein the cue point component is configured to hierarchically rank a plurality of cue points, with the highest ranking cue points being selected as the cue points for the song within the mix, and, others being available to a user as alternative cue points for the song during mix customization.

The system can include wherein the transition component is configured to derive musical information about a section that each cue point represents and at least one of a transition duration or a set of effects applied to the transition based on the derived musical information. The system can further include wherein the set of effects comprises volume and beat matching.

The system can include wherein the transition component is further configured to generate alternative transition options for a particular song in the mix, the alternative transitions being available to a user as alternative transitions for the particular song during mix customization. The system can further include wherein the mix metadata comprises a set of JavaScript Object Notation (JSON) instructions.

Described herein is a method of automatically mixing music, comprising: receiving information regarding a set of songs; obtaining pre-analyzed metadata about songs in the set of songs; based upon the pre-analyzed metadata, ordering the songs into a mix based upon an analysis of beats-per-minute and song key; based upon a user preference, selecting one or more cue points from the pre-analyzed metadata for transitions into and/or out of the songs in the mix; based upon the user preference and information derived from the pre-analyzed metadata for each section of a particular song, configuring transitions between songs in the mix; and storing metadata about the mix for playback.

The method can include receiving user input to modify the mix comprising at least one of modification of a particular cue point or modification of a particular transition. The method can further include receiving user input via a graphical user interface allowing a user to selectively adjust at least one of a duration, an effect or a volume curve of a particular transition. The method can include wherein the pre-analyzed metadata comprises at least one of a genre, beats-per-minute or a song key.

The method can include wherein the pre-analyzed metadata comprises information regarding one or more section(s) of a particular song including at least one of an average energy, a duration time, a cue point or transition information associated with a cue point. The method can further include hierarchically ranking a plurality of cue points, with the highest ranking cue points being selected as the cue points for the song within the mix, and, others being available to a user as alternative cue points for the song during mix customization.

Described herein is a computer storage media storing computer-readable instructions that when executed cause a computing device to: receive a user selection of a song to add to a mix; obtain metadata for the added song; based on a stored user preference, select cut points for transitions into and out of the song; for each cue point, based on the stored user preference and obtained metadata, configure transitions into and out of the song; and store information regarding the mix.

The computer storage media can store further computer-readable instructions that when executed cause the computing device to receive a user customization of the mix. The computer storage media can store further computer-readable instructions that when executed cause the computing device to perform the recited acts iteratively for a plurality of songs. The computer storage media can further include wherein the obtained metadata comprises at least one of a genre, beats-per-minute or a song key.

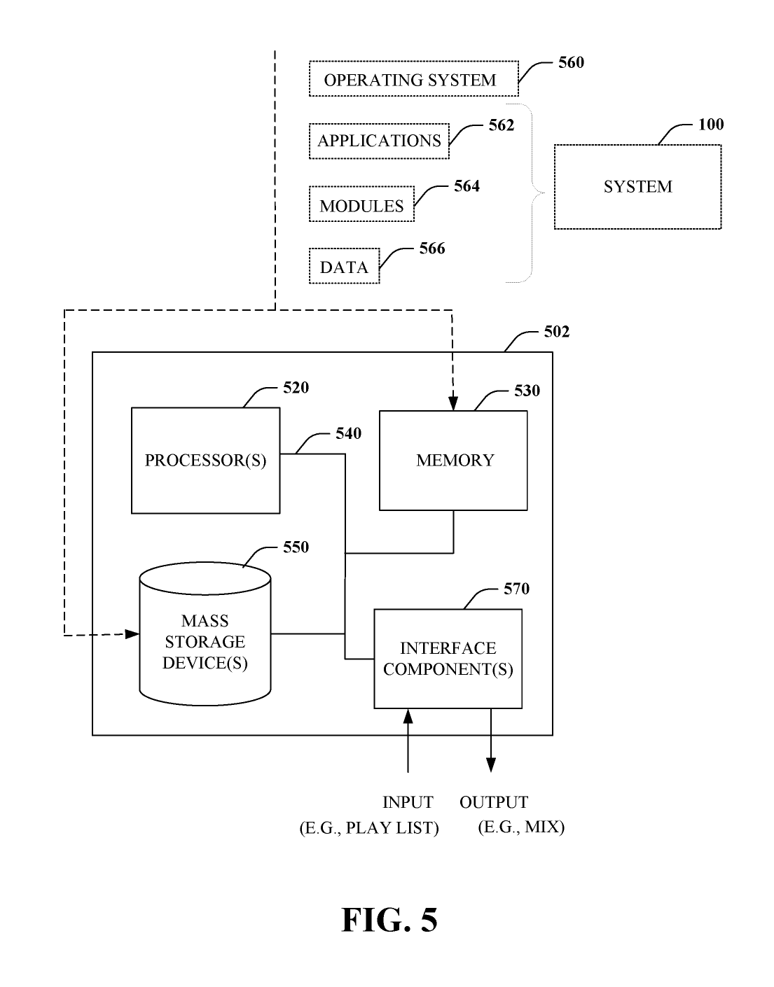

With reference to FIG. 5, illustrated is an example general-purpose computer or computing device 502 (e.g., mobile phone, desktop, laptop, tablet, watch, server, hand-held, programmable consumer or industrial electronics, set-top box, game system, compute node, etc.). For instance, the computing device 502 may be used in a system for automatically mixing music 100, 200.

The computer 502 includes one or more processor(s) 520, memory 530, system bus 540, mass storage device(s) 550, and one or more interface components 570. The system bus 540 communicatively couples at least the above system constituents. However, it is to be appreciated that in its simplest form the computer 502 can include one or more processors 520 coupled to memory 530 that execute various computer executable actions, instructions, and or components stored in memory 530. The instructions may be, for instance, instructions for implementing functionality described as being carried out by one or more components discussed above or instructions for implementing one or more of the methods described above.

The processor(s) 520 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 520 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 520 can be a graphics processor.

The computer 502 can include or otherwise interact with a variety of computer-readable media to facilitate control of the computer 502 to implement one or more aspects of the claimed subject matter. The computer-readable media can be any available media that can be accessed by the computer 502 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 502. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 530 and mass storage device(s) 550 are examples of computer-readable storage media. Depending on the exact configuration and type of computing device, memory 530 may be volatile (e.g., RAM), non-volatile (e.g., ROM, flash memory, etc.) or some combination of the two. By way of example, the basic input/output system (BIOS), including basic routines to transfer information between elements within the computer 502, such as during start-up, can be stored in nonvolatile memory, while volatile memory can act as external cache memory to facilitate processing by the processor(s) 520, among other things.

Mass storage device(s) 550 includes removable/non-removable, volatile/non-volatile computer storage media for storage of large amounts of data relative to the memory 530. For example, mass storage device(s) 550 includes, but is not limited to, one or more devices such as a magnetic or optical disk drive, floppy disk drive, flash memory, solid-state drive, or memory stick.

Memory 530 and mass storage device(s) 550 can include, or have stored therein, operating system 560, one or more applications 562, one or more program modules 564, and data 566. The operating system 560 acts to control and allocate resources of the computer 502. Applications 562 include one or both of system and application software and can exploit management of resources by the operating system 560 through program modules 564 and data 566 stored in memory 530 and/or mass storage device (s) 550 to perform one or more actions. Accordingly, applications 562 can turn a general-purpose computer 502 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 562, and include one or more modules 564 and data 566 stored in memory and/or mass storage device(s) 550 whose functionality can be realized when executed by one or more processor(s) 520.

In accordance with one particular embodiment, the processor(s) 520 can correspond to a system on a chip (SOC) or like architecture including, or in other words integrating, both hardware and software on a single integrated circuit substrate. Here, the processor(s) 520 can include one or more processors as well as memory at least similar to processor(s) 520 and memory 530, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 502 also includes one or more interface components 570 that are communicatively coupled to the system bus 540 and facilitate interaction with the computer 502. By way of example, the interface component 570 can be a port (e.g., serial, parallel, PCMCIA, USB, FireWire, etc.) or an interface card (e.g., sound, video, etc.) or the like. In one example implementation, the interface component 570 can be embodied as a user input/output interface to enable a user to enter commands and information into the computer 502, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 570 can be embodied as an output peripheral interface to supply output to displays (e.g., LCD, LED, plasma, etc.), speakers, printers, and/or other computers, among other things. Still further yet, the interface component 570 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for automatically mixing music, comprising:
a computer comprising a processor and a memory, the memory comprising:
an ordering component configured to receive information regarding a set of songs, obtain pre-analyzed metadata about songs in the set of songs, and, based upon the pre-analyzed metadata order the songs into a mix based upon an analysis of beats-per-minute and song key;
a cue point component configured to, based upon a user preference, selects one or more cue points from the pre-analyzed metadata for transitions into and/or out of the songs in the mix; and
a transition component configured to, based upon the user preference and information derived from the pre-analyzed metadata for each section of a particular song, configure transitions between songs in the mix,
wherein the system further stores metadata about the mix for playback.

2. The system of claim 1, the memory further comprising a mix customization component configured to receive user input to modify the mix comprising at least one of modification of a particular cue point or modification of a particular transition.

3. The system of claim 1, the memory further comprising a mix customization component configured to receive user input via a graphical user interface allowing a user to selectively adjust at least one of a duration, an effect or a volume curve of a particular transition.

4. The system of claim 1, wherein the pre-analyzed metadata comprises at least one of a genre, beats-per-minute or a song key.

5. The system of claim 1, wherein the pre-analyzed metadata comprises information regarding one or more section(s) of a particular song including at least one of an average energy, a duration time, a cue point or transition information associated with a cue point.

6. The system of claim 1, wherein the cue point component is configured to hierarchically rank a plurality of cue points, with the highest ranking cue points being selected as the cue points for the song within the mix, and, others being available to a user as alternative cue points for the song during mix customization.

7. The system of claim 1, wherein the transition component is configured to derive musical information about a section that each cue point represents and at least one of a transition duration or a set of effects applied to the transition based on the derived musical information.

8. The system of claim 7, wherein the set of effects comprises volume and beat matching.

9. The system of claim 7, wherein the transition component is further configured to generate alternative transition options for a particular song in the mix, the alternative transitions being available to a user as alternative transitions for the particular song during mix customization.

10. The system of claim 1, wherein the mix metadata comprises a set of JavaScript Object Notation (JSON) instructions.

11. A method of automatically mixing music, comprising:
receiving information regarding a set of songs;
obtaining pre-analyzed metadata about songs in the set of songs;
based upon the pre-analyzed metadata, ordering the songs into a mix based upon an analysis of beats-per-minute and song key;
based upon a user preference, selecting one or more cue points from the pre-analyzed metadata for transitions into and/or out of the songs in the mix;
based upon the user preference and information derived from the pre-analyzed metadata for each section of a particular song, configuring transitions between songs in the mix; and
storing metadata about the mix for playback.

12. The method of claim 11, further comprising receiving user input to modify the mix comprising at least one of modification of a particular cue point or modification of a particular transition.

13. The method of claim 11, further comprising receiving user input via a graphical user interface allowing a user to selectively adjust at least one of a duration, an effect or a volume curve of a particular transition.

14. The method of claim 11, wherein the pre-analyzed metadata comprises at least one of a genre, beats-per-minute or a song key.

15. The method of claim 11, wherein the pre-analyzed metadata comprises information regarding one or more section(s) of a particular song including at least one of an average energy, a duration time, a cue point or transition information associated with a cue point.

16. The method of claim 10, further comprising hierarchically ranking a plurality of cue points, with the highest ranking cue points being selected as the cue points for the song within the mix, and, others being available to a user as alternative cue points for the song during mix customization.

17. A computer storage media storing computer-readable instructions that when executed cause a computing device to:
receive a user selection of a song to add to a mix;
obtain metadata for the added song;
based on a stored user preference, select cut points for transitions into and out of the song;
for each cue point, based on the stored user preference and obtained metadata, configure transitions into and out of the song; and
store information regarding the mix.

18. The computer storage media of claim 17, storing further computer-readable instructions that when executed cause the computing device to receive a user customization of the mix.

19. The computer storage media of claim 17, storing further computer-readable instructions that when executed cause the computing device to perform the recited acts iteratively for a plurality of songs.

20. The computer storage media of claim 17, wherein the obtained metadata comprises at least one of a genre, beats-per-minute or a song key.
